(19) United States
(12) Patent Application Publication
(10) Pub. No.: US 2008/0160869 A1
(43) Pub. Date: Jul. 3, 2008

(54) METHOD FOR MANUFACTURING A FIELD EMISSION ELEMENT AND A FIELD EMISSION DEVICE

(75) Inventors: Hung-Yuan LI, Taipei (TW); Tsuey-May Yin, Taipei (TW)

Correspondence Address: LOWE HAUPTMAN HAM & BERNER, LLP, 1700 DIAGONAL ROAD, SUITE 300, ALEXANDRIA, VA, 22314, US

(73) Assignee: Tatung Company, Taipei (TW)

(21) Appl. No.: 11/966,371

(22) Filed: Dec. 28, 2007

(30) Foreign Application Priority Data
Dec. 29, 2006 (TW) 095149951

(51) Int. Cl. H01J 9/00

(52) U.S. Cl. 445/24

(57) ABSTRACT

The present invention provides a method for manufacturing a field emission element, comprising: providing a substrate having a patterned gate layer thereon; forming a patterned photoresist layer on the substrate, wherein the photoresist layer has an opening; sequentially forming a cathode layer and an emitter layer in the opening of the photoresist layer; and removing the photoresist layer. The present invention further provides a method for manufacturing a field emission device using the aforementioned field emission element. The present invention can effectively enhance the preciseness of the field emission element and emitter, and enhance the resolution of the display.

### RELATED APPLICATIONS

The present application is based on, and claims priority from, Taiwanese Patent Application Number 095149951, filed Dec. 29, 2006, the disclosure of which is hereby incorporated by reference herein in its entirety.

### BACKGROUND OF THE INVENTION

1. Field of the Invention

The present invention relates to a method for manufacturing a field emission element and a field emission device and, more particularly, to a method for manufacturing a field emission element and a field emission device using a hydrophilic paste for a pattern emitter layer.

2. Description of Related Art

Electronic displays are more and more important for daily life. In addition to computers or internet, televisions, mobile phones, personal digital assistants, and digital cameras all need displays to express signals. In comparison with a conventional cathode ray tube display, a new flat panel display exhibits advantages of light-weight, compact-size, and reduced health damage but the issues of view angle, brightness, power consumption and so on still need to be improved.

Among the new flat panel displays, a field emission display (FED) not only has high-quality equal to that of a conventional cathode ray tube display, but also has the advantages of short reaction-time, high brightness (more than 100 ftL), light and thin structure, wide view angle, and broad range of action temperature in comparison with the disadvantages of narrow view angle, narrow range of action temperature, and long reaction-time of a liquid crystal display.

In addition, a field emission display does not need a backlight module. Thus, even if used outdoors, a field emission display still can provide excellent brightness. Due to the development of nano-techniques, it is popular to design a new emitter element used for a field emission display. A carbon nanotube applied to field emission element also replaces a conventional element for tip discharge. Thereby, it is believed that a field emission display has the ability to compete with a liquid crystal display, and can even replace a liquid crystal display.

The action principle of a field emission display is similar to that of a conventional cathode ray tube based display. Electrons can eject in a vacuum condition (lower than 10⁻⁶ torr) by electric field and are accelerated by positive voltage on an anode plate to impact the fluorescence powder of the anode plate and thereby the anode plate emits light. In general, electrons can eject from each emitter at a predetermined time by controlling the voltage difference between the cathode and the gate of the field emission display.

A conventional field emission display comprises an upper plate called anode including fluorescence layer, a lower plate called cathode including an insulating layer, an emitter layer and a gate layer. The anode and the cathode are assembled and packed by a colloid layer formed between the anode and the cathode, and the space between the anode and the cathode is in a vacuum state. In a conventional process, the emitter layer is formed by screen printing. However, the emitter layer formed by screen printing cannot meet the requirements for preciseness since using a screen in manufacturing a broad-area pattern causes severe position-shift. In addition, the conventional photolithography process for forming a patterned emitter layer cannot provide a broad-area emitter layer and the cost is too high. Therefore, it is desirable to provide a manufactured method to overcome the aforementioned problems.

### SUMMARY OF THE INVENTION

The present invention provides a method for manufacturing a field emission element, comprising: providing a substrate having a patterned gate layer thereon first, wherein the pattern of the gate layer can be in any shape, such as strip, circle, ring and so on; subsequently, forming a patterned photoresist layer on the substrate, wherein the photoresist layer has an opening, and the shape and the size of the opening are not limited; then, sequentially forming a cathode layer and an emitter layer in the opening of the photoresist layer; and finally, removing the photoresist layer to obtain the field emission element of the present invention.

In addition, the present invention further provides a method for manufacturing a field emission device, comprising: providing an anode having a fluorescence layer sequentially formed thereon; providing a cathode having a patterned gate layer thereon; forming a patterned photoresist layer on the substrate, wherein the photoresist layer has an opening; sequentially forming a cathode layer and an emitter layer in the opening of the photoresist layer; removing the photoresist layer; and finally, assembling and packing the anode and the cathode to obtain the field emission device of the present invention.

Preferably, the cathode layer is formed in the opening of the photoresist by screen printing, spray coating, or spin coating. In addition, after forming the cathode layer in the opening of the photoresist layer, preferably, the opening of the photoresist having the cathode layer therein is filled completely with a hydrophilic emitter solution by capillary effect. Preferably, the hydrophilic emitter solution is formed on the cathode layer by spray coating, dropping, or spin coating. Furthermore, the hydrophilic emitter solution of the present invention consists of an organic solution and an emitter material. The organic solution is not limited and any hydrophilic organic solution can be used. Preferably, the organic solution is an alcohol-containing organic solution. In addition, the material of the emitter layer comprises a carbon-containing compound, and the carbon-containing compound is selected from the group consisting of graphite, diamond, diamond-like carbon, carbon nanotube, buckminsterfullerene, and a combination thereof. Preferably, the material of the carbon-containing compound is carbon nanotube.

The material of the photoresist layer of the present invention is not limited. Preferably, the material of the photoresist layer is a hydrophobic and temperature-proof (higher than 80° C.) photoresist material. More preferably, the material of the photoresist layer is a hydrophobic, acid-proof, and alkali-proof photoresist material.

Preferably, the gate layer of the present invention is formed by a photolithography process.

The field emission device of the present invention can be a field emission display or a field emission backlight device.

Thereby, the methods for manufacturing a field emission element and a field emission device using the same of the present invention can resolve the problems that the conventional screen printing for manufacturing a cathode cannot provide a precise emitter layer and the conventional photolithography process for forming a patterned emitter layer cannot provide a broad-area emitter layer and the cost is too high. In addition, the present invention using the photolithography process can reduce the sizes of the cathode layer and the emitter layer to 1˜500 μm, and enhance the resolution of the element and the display. Furthermore, the manufacturing method of the present invention enables self-alignment of the emitter layer to the gate layer so as to inhibit the electrical connection between the emitter layer and the gate layer, which would occur in a screen printing process resulting from the shift of a screen.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1A to 1D are cross section views of a method for manufacturing a field emission element of a preferred embodiment of the present invention;

FIG. 2 is a cross section view of a field emission device of a preferred embodiment of the present invention;

FIG. 3 is a bottom view of a cathode of a field emission display of a preferred embodiment of the present invention;

FIG. 4 is a cross section view of B region of a cathode of a field emission display of a preferred embodiment of the present invention; and

FIG. 5 is a view of a field emission backlight panel of a preferred embodiment of the present invention.

### DETAILED DESCRIPTION OF THE PREFERRED EMBODIMENT

### Embodiment 1

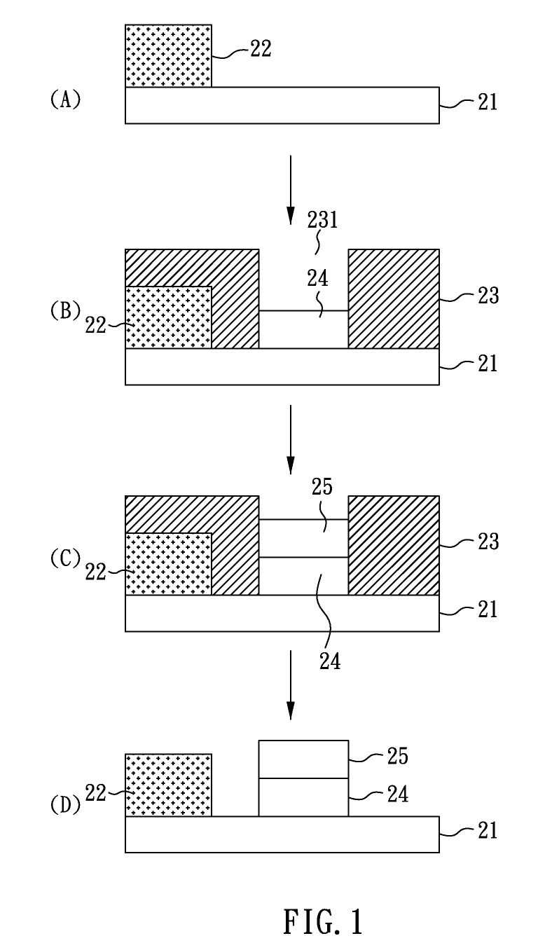

FIGS. 1A to 1D show a process for manufacturing the field emission element of the present invention.

As shown in FIG. 1A, a glass substrate 21 is provided first. A conductive layer 21 is formed on the glass substrate 21, and the conductive layer is patterned by a photolithography process to form a patterned gate layer 22. The width of the gate layer 22 can be 1˜500 μm. Preferably, the width of the gate layer 22 is 10˜30 μm. The width of the gate layer of the present embodiment is 10 μm.

Subsequently, as shown in FIG. 1B, a patterned photoresist layer 23 is formed on the surface of the glass substrate 21 having the patterned gate layer 22 thereon, and an opening 231 is formed in the photoresist layer 23 by exposure and development. In the present embodiment, the material of the photoresist layer 23 can be a hydrophobic photoresist material and the hydrophobic photoresist material can exhibit the temperature-proof (higher than 80° C.), acid-proof and alkali-proof properties. Then, a metal paste can be plated in the opening 231 of the photoresist layer 23 by screen printing, spray coating, sputtering, or spin coating. In the present embodiment, the metal paste is deposited in the opening 231 of the photoresist layer 23 by spin coating. The metal paste can be heat-treated at 80˜100° C., and then is solidified by sintering so as to function as a cathode layer 24. The width of the cathode layer 24 depends on that of the opening and can be 1˜500 μm. Preferably, the width of the cathode layer 24 is 10˜30 μm. In the present embodiment, the width of the cathode layer 24 is 10 μm. And the gap between gate layer 22 and cathode layer 24 is 1˜30 μm. Preferably, the gap between gate layer 22 and cathode layer 24 is 10 μm.

Then, as shown in FIG. 1C, the opening 231 of the photoresist layer 23 having the cathode layer 24 therein is filled completely with a hydrophilic emitter solution by capillary effect to form an emitter layer 25 on the cathode layer 24. In the present embodiment, the opening 231 of the photoresist layer 23 having the cathode layer 24 therein can be filled completely by screen printing, spray coating, dropping, or spin coating the hydrophilic emitter solution on the glass substrate 21. All methods which can fill completely the opening of the photoresist layer can be used. In the present embodiment, the hydrophilic emitter solution is formed on the glass substrate 21 by spin coating. The hydrophilic emitter solution is an alcohol-containing organic solution, and the major material of the emitter layer 25 is carbon nanotube. In the present embodiment, when the hydrophilic emitter solution is deposited in the opening 231 of the photoresist layer 23, the hydrophilic emitter solution can rapidly and uniformly flow resulting from the hydrophility of the hydrophilic emitter solution for the emitter layer 25 and the hydrophobility of the photoresist material for the photoresist layer 23 so as to form a cathode structure with a precise pattern.

Finally, as shown in FIG. 1D, the photoresist layer 23 is removed to obtain the field emission element of the present invention.

### Embodiment 2

The method of the present embodiment is similar to that of Embodiment 1. However, as shown in FIG. 1C, in the present embodiment, the opening 231 of the photoresist layer 23 having the cathode layer 24 therein is filled completely by dropping which is different from spin coating used in Embodiment 1. Other steps in the present embodiment are the same as those in Embodiment 1.

### Embodiment 3

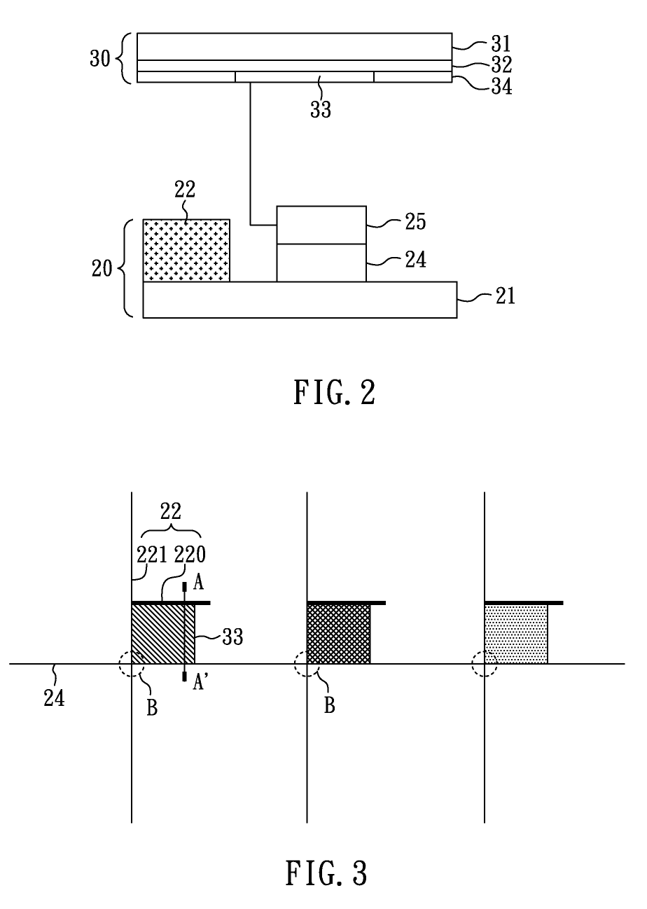

FIGS. 2 and 3 show a cross section view of the field emission display and a bottom view of the cathode, respectively. FIG. 2 shows a cross section view of the field emission display along AA′ line in FIG. 3.

As shown in FIG. 2, a glass substrate 31 is provided first, and an anode layer 32 is formed on the glass substrate 31. The anode layer 32 is an electrode consisting of transparent conductive materials such as indium-tin oxide (ITO) transparent conductive material. Then, a fluorescence layer 33 and a black matrix 34 are formed on the anode layer 32. The fluorescence layer 33 consists of fluorescence powder. Accordingly, an anode 30 used for a field emission device is accomplished.

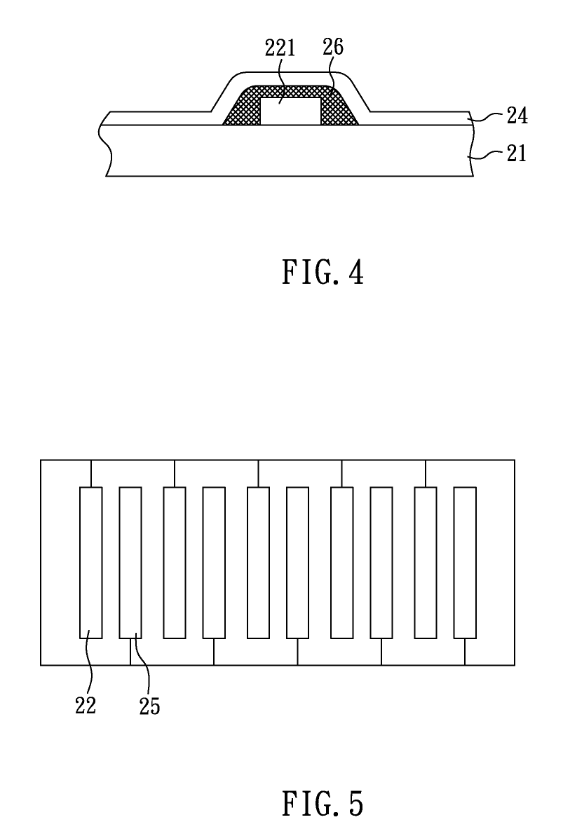

In addition, the present embodiment also provides a cathode 20 used for a field emission device. A spacer is sandwiched in between the anode 30 and the cathode 20, and the spacer, the anode, and the cathode are assembled and packed so as to obtain the field emission device of the present invention. In the present embodiment, the cathode 20 can be fabricated by the process of Embodiment 1. When patterning the gate layer 22 on the glass substrate 21, gate lines 221 and gate branch lines 222 can be formed simultaneously, as shown in FIG. 3, and the gate layer 22 in FIG. 2 is equal to the gate branch line 222 in FIG. 3. In addition, before forming the photoresist layer 23, a patterned insulating layer 24 (as shown in FIG. 4 and the B region in FIG. 3) is formed. The material of the insulating layer 26 is not limited. Preferably, the material of the insulating layer 26 is silicon nitride, silica, lead oxide, magnesium oxide, or ceramic materials. In the present embodiment, the material of the insulting layer is silica. The patterned insulating layer 26 is formed in the region wherein the cathode layer 24 and the gate lines 221 overlap each other. FIG. 2 shows a cross section view of the field emission device along AA′ line in FIG. 3. FIG. 3 shows the arrangement of the gate branch lines 222 of the gate layer 24 and the fluorescence layer 33 of the anode 30. After assembling and packing, electrons eject laterally from the emitter layer 25 to impact the fluorescence layer 33 of the anode 30 and then the fluorescence layer 33 emits light. The fluorescence layer 33 can display red, green, and blue.

### Embodiment 4

FIG. 5 shows a view of the field emission backlight panel of the present invention. The present embodiment forms the gate layer 22 and the emitter layer 25 by the process of Embodiment 1. The gate layer 22 and the emitter layer 25 are parallel to each other and the shapes of the gate layer 22 and the emitter layer 2 are strip-like. The layer below the emitter layer 25 is the cathode layer 24, as shown in FIG. 1D. Then, as shown in FIG. 2, an anode can be provided by the process of Embodiment 2. In the field emission backlight panel of the present embodiment, electrons can eject from the emitter layer 25 to impact the fluorescence layer 33 and then the fluorescence layer 33 emits light.

In the present invention, after the patterned photoresist layer is formed on the substrate and the cathode layer is formed in the opening of the photoresist layer, the emitter solution can flow rapidly and uniformly by capillary effect and the hydrophility of the emitter solution when the opening of the photoresist layer is filled completely [filled] with the emitter solution. Thereby, a cathode structure of a precise pattern can be provided, and a broad-area pattern can be readily accomplished. In addition, the manufacturing method of the present invention can enhance the preciseness of the electron ejection so as to enhance the resolution of a field emission display.

Although the present invention has been explained in relation to its preferred embodiment, it is to be understood that many other possible modifications and variations can be made without departing from the spirit and scope of the invention as hereinafter claimed.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalent thereof.

What is claimed is:

1. A method for manufacturing a field emission element, comprising:
providing a substrate having a patterned gate layer thereon;
forming a patterned photoresist layer on the substrate, wherein the photoresist layer has an opening;
sequentially forming a cathode layer and an emitter layer in the opening of the photoresist layer; and
removing the photoresist layer.

2. The method as claimed in claim 1, wherein the cathode layer is formed in the opening of the photoresist by spin coating.

3. The method as claimed in claim 1, wherein the opening of the photoresist having the cathode layer therein is filled completely with a hydrophilic emitter solution by capillary effect after forming the cathode layer.

4. The method as claimed in claim 3, wherein the opening of the photoresist having the cathode layer therein is filled completely with the hydrophilic emitter solution by dropping.

5. The method as claimed in claim 3, wherein the opening of the photoresist having the cathode layer therein is filled completely with the hydrophilic emitter solution by spin coating.

6. The method as claimed in claim 3, wherein the hydrophilic emitter solution consists of an organic solution and an emitter material.

7. The method as claimed in claim 6, wherein the emitter material comprises a carbon-containing compound, and the carbon-containing compound is selected from the group consisting of graphite, diamond, diamond-like carbon, carbon nanotube, buckminsterfullerene, and a combination thereof.

8. The method as claimed in claim 1, wherein the gate layer is formed by a photolithography process.

9. A method for manufacturing a field emission device, comprising:
providing an anode having an anode layer and a fluorescence layer sequentially formed thereon;
providing a cathode having a patterned gate layer thereon;
forming a patterned photoresist layer on the cathode, wherein the photoresist layer has an opening;
sequentially forming a cathode layer and an emitter layer in the opening of the photoresist layer;
removing the photoresist layer; and
assembling and packing the anode and the cathode.

10. The method as claimed in claim 9, wherein the cathode layer is formed in the opening of the photoresist by spin coating.

11. The method as claimed in claim 9, wherein the opening of the photoresist having the cathode layer therein is filled completely with a hydrophilic emitter solution by capillary effect after forming the cathode layer.

12. The method as claimed in claim 11, wherein the opening of the photoresist having the cathode layer therein is filled completely with the hydrophilic emitter solution by dropping.

13. The method as claimed in claim 11, wherein the opening of the photoresist having the cathode layer therein is filled completely with the hydrophilic emitter solution by spin coating.

14. The method as claimed in claim 11, wherein the hydrophilic emitter solution consists of an organic solution and an emitter material.

15. The method as claimed in claim 9, wherein the gate layer is formed by a photolithography process.
